(19) United States
(12) Patent Application Publication
(10) Pub. No.: US 2021/0239232 A1
(43) Pub. Date: Aug. 5, 2021

(54) BLOW-OFF VALVE WITH DUAL AXIS INTERNAL SEAL RING

(71) Applicant: PADMINI VNA MECHATRONICS PVT. LTD., GURGAON (IN)

(72) Inventors: KABIR BHANDARI, NEW DELHI (IN); AMARDIP KUMAR, GURGAON (IN); KUMAR ABHISHEK, Gurgaon (IN); PARSURAM ROUT, Gurgaon (IN)

(21) Appl. No.: 16/973,506

(22) PCT Filed: Jun. 10, 2019
(86) PCT No.: PCT/IB2019/054810

§ 371 Date: Dec. 9, 2020

(30) Foreign Application Priority Data
Jun. 9, 2018 (IN) 201811021628

(51) Int. Cl. F16K 31/06; F02B 37/16

(52) U.S. Cl. CPC F16K 31/0655; F16K 31/0693; F02B 37/16

(57) ABSTRACT

The present invention provides a blow-off valve for an internal combustion engine. More specifically, the invention provides a blow-off valve with dual axis internal seal ring that works in axial and radial direction to improve the leakage while reducing the child parts of assembly. The blow-off valve provided comprises of a plunger body, a compression spring, a moving core, a two axis internal seal ring, a fix core, a bobbin, coil, coil housing, a plunger housing and terminals to power up the coil.

### FIELD OF THE INVENTION

The present invention provides a blow-off valve for an internal combustion engine. More specifically, the invention provides a blow-off valve with dual axis internal seal ring that works in axial and radial direction to improve the leakage while reducing the child parts of assembly.

### BACKGROUND OF THE INVENTION

Superchargers are utilized in internal combustion engines to increase volumetric efficiency of the engines and thereby to enhance the performance of the engines. When the throttle of such an engine closes during operation, certain detrimental effects can result. These include a build-up of pressure downstream of the throttle with a resultant undesirable increase in heat, a rapid deceleration of the supercharger compressor with a resultant increase in potentially damaging or wearing forces on the compressor, excessive and unpleasant noise effects, and an increase in the ratio of fuel in the fuel/air mixture supplied to the engine which results in the engine running rich.

In an attempt to overcome these disadvantages, a blow-off valve may be provided downstream of the supercharger compressor outlet. A blow-off valve is a pressure release system present in most turbocharged engines that functions to prevent compressor surge and reduce wear on the turbocharger system and engine. Blow-off valves relieve the damaging effects of compressor “surge loading” by allowing the compressed air to vent to the atmosphere or to re-circulate into the intake upstream of the compressor inlet. In most cases the blow-off valves open a blow-off port to release the air under pressure in the surrounding atmosphere, thus prevent any damage to the compressor part.

Typically a blow-off valve is a safety mechanism on the turbo that ‘manages’ the boost produced by the turbo. The blow-off valve is actuated by a diaphragm which is controlled via solenoid. The solenoid itself is controlled by the engine management system (ECU). When the solenoid receives a signal from the ECU, to opens the valves to bypass the gasses around the exhaust turbine in the turbo and allows pressure to be maintained in a safe zone. Since a blow-off valve is a critical part for the safety of the machine it must be highly reliable. Besides, a blow-off valve should be capable to induce a pressure drop within nearly zero amount of time to avoid a longer duration of dangerous conditions. Therefore, blow-off valves are designed preferably simple and robust. Since, the blow-off valve should be capable to induce a pressure drop immediately a blow-off valve must be capable for a very high flow rate in the opening position and therefore it is usually big in size. The fast actuation of a big free piston in the body of the valve needs a very powerful actuation of the valve, which also must be extremely reliable at the same time it is required that it will not waste necessary pressure built at the entry. All these requirements of extreme operating conditions lead to expensiveness especially of the actuation of the blow-off valve.

In Patent No. DE102015212913A1, discloses a diverter valve for regulating the pressure in an intake path of an internal combustion engine, having a housing and formed with an in the housing flow path, the flow path can be released by an attachable onto a valve seat piston and/or is closable, wherein the piston with a pin is connected, which is movable by means of an electromagnetically producible force, wherein a movement of the pin on the piston is transmitted, the bearing is realized of the pin within the diverter valve by precisely one sliding sleeve, wherein the pin relative to the sliding sleeve is movable. The drawback associate to invention is that, it is very complex in design and consecutively costly due to large number of components.

In Patent No. DE102014113540B3, discloses a diverter valve for a compressor of an internal combustion engine having a flow housing, in which a channel is formed, an electromagnetic actuator, a control body is movable by means of the actuator, and by means of which a flow cross section of the channel is adjustable, a housing interior in which a connected to the control body armature of the electromagnetic actuator is movable openings in the control body, through which the casing interior is connected to an axially abutting on the regulating part of the body of the channel in the flow housing fluidically, a valve housing which surrounds the electromagnetic actuator and an axial extension portion of the control body radially, a radial seal, via which the housing interior is sealed to a radially applied to the control body part of the duct and rests axially on an annular radially inwardly facing plate of a support ring, the radially from Auss having a cylindrical wall against a housing wall of the valve housing abuts. Again, it is very complex in design and consecutively costly due to large number of components.

In U.S. Pat. No. 8,387,383B2, discloses a valve having a housing which incorporates an electromagnetic drive unit and a valve unit movable in the housing. The valve unit has a valve rod and a valve closing body attached thereto and a circular sealing element. An arrangement is provided to keep the moving valve unit in a closed position when no current is supplied to the valve unit. At least one pressure compensation opening is provided in the moving valve unit, and the valve closing body has a cylindrical lateral surface which is arranged in such a manner that a housing interior is sealed towards the pressure side or the intake side. Being a complex designed assembly and large number of components, the valve will be costly to produce and needs more accuracy check while being assembled.

The advent of increasingly powerful engines and performance turbo charging systems, the demand for blow-off valves have increased exponentially. Therefore, as we can deduce from the state of art that a blow-off valve is required, while focusing towards eliminating the plurality of components to promote a simple and favorable design yet maintaining its working performance and efficiency which results in reducing manufacturing cost.

### OBJECT OF THE INVENTION

The main object of the invention is to provide a blow-off valve with dual axis internal seal ring to avoid the internal leakage while reducing the child parts of assembly.

Yet another object of the invention is to provide a blow-off valve with improved design complexity and low manufacturing cost.

### SUMMARY OF THE INVENTION

The present invention provides a blow-off valve for an internal combustion engine. More specifically, the invention provides a blow-off valve with dual axis internal seal ring that works in axial and radial direction to improve the leakage while reducing the child parts of assembly. Further, the dual axis internal seal can compensate the dimensional flexibility of the blow-off valve.

In an embodiment of the present invention, the blow-off valve provided comprises of a plunger body, a compression spring, a moving core, a two axis internal seal ring, a fix core, a bobbin, coil, coil housing, a plunger housing and terminals to power up the coil.

In another embodiment of the present invention, a plunger body is provided which is also acting like a spring seat and secured inside a plunger housing with a compression spring. The plunger body is provided with means of pins, inserts, etc. which allows it to assembled into the moving core without any additional attachments. Plunger body is then inserted into the plunger housing using dual or two axis internal seal ring which improves the internal leakage in axial and radial direction. Further, the over molded coil housing and plunger housing are press fitted and sealed to form a fully functional blow-off valve. The fix core provides a magnetic path to attract the moving core upward against the spring force of the compression spring when coil is energized. When the coil is de-energized, the moving core is separated from the fixed core by the action of compression spring to return the plunger body in the opposite direction.

In another embodiment of the present invention, an over molded coil assembly is provided that includes a bobbin formed from an electrically insulated material such as, thermoplastics, nylon, etc., with a bore extending axially. Further, a metallic coil of conducting material such as copper is then wound or wrapped around the bobbin, which when energized sets up a magnetic field. At the distal end of bobbin, a fix core is attached. Further, a compression spring is co-axially inserted into the moving core at other end. At one end, terminal pins are connected with in bobbin to which coil's end are connected for receiving electrical input.

In another embodiment of the present invention, the dual axis internal seal ring will remains fix in its position i.e. in co-axial between plunger housing and plunger body, while operation and let the plunger body to perform opening and closing which result in lower opening and closing time of blow-off valve and have less chances of wear and tear. Further, it allows dimensional flexibility for sealing depth of overall blow-off valve because of its own compressibility.

In another embodiment of the present invention, the blow-off valve with dual axis internal seal ring assisting in reducing child parts of overall assembly which improves the design complexity and assist in lowering the overall manufacturing cost.

### BRIEF DESCRIPTION OF THE DRAWINGS

The object of the invention may be understood in more details and more particularly description of the invention briefly summarized above by reference to certain embodiments thereof which are illustrated in the appended drawings, which drawings form a part of this specification. It is to be noted, however, that the appended drawings illustrate preferred embodiments of the invention and are therefore not to be considered limiting of its scope, for the invention may admit to other equally effective equivalent embodiments.

FIG. 1 shows the sectional view of a conventional blow-off valve for regulating the pressure in an intake path of an internal combustion engine.

FIGS. 2a and 2b show the sectional and side cross-sectional view of a blow-off valve with two axis internal seal ring in accordance with an embodiment of the present invention.

FIG. 3 shows the valve leakage performance between conventional blow-off valve and blow-off valve with two axis internal seal ring in accordance with an embodiment of the present invention.

### DETAILED DESCRIPTION OF THE INVENTION

The present invention will now be described more fully hereinafter with reference to the accompanying drawings in which a preferred embodiment of the invention is shown.

This invention may, however, be embodied in many different forms and should not be construed as being limited to the embodiment set forth herein. Rather, the embodiment is provided so that this disclosure will be thorough, and will fully convey the scope of the invention to those skilled in the art.

In a most preferred embodiment, the present invention provides a blow off valve with improved internal leakage comprising of: a plunger body, a compression spring, a moving core, a two axis internal seal ring, a fix core, a bobbin, a metallic coil, a coil housing, a plunger housing and a plurality of terminal pins; wherein, the two axis internal seal ring remains fixed co-axially between the plunger housing and the plunger body; the two axis internal seal ring is having two lips for sealing internal leakage from horizontal as well as vertical surface between the plunger housing and plunger body; and the two axis internal seal ring reduces the leakage by 30-35% at a pressure of 180 kPa in axial and radial direction.

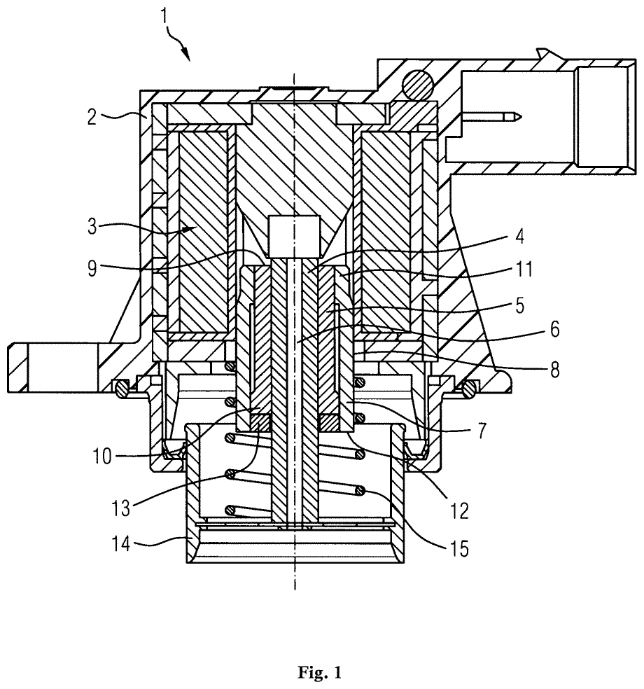

FIG. 1 shows the sectional view of a conventional blow-off valve 1 comprising; a housing 2 through which a flow may pass along a flow section. An electromagnet 3 is arranged in the housing 2, which is powered by a voltage source (not illustrated) whereby electromagnetic forces are produced, which act on the pin 4 arranged in the blow-off valve 1. The pin 4 is formed in the shape of a rod with a circular cross-section and has a central axial through-bore 6 extending through it. The pin 4 is guided in a sliding sleeve 5 and may be moved upward and downward relative to the sliding sleeve 5 in a translatory direction. The sliding sleeve 5 is formed as a tubular body and surrounds the pin 4 completely in the circumferential direction. The sliding sleeve 5 is received in a bearing sleeve 7, which is in turn received in a suitable opening 8 in the housing 2. The sliding sleeve 5 and the bearing sleeve 7 are pressed together. The sliding sleeve 5 has a smaller outer diameter at its upwardly directed end region 9 than at its downwardly directed end region 10. The bearing sleeve 7 has a smaller inner diameter at its upper end region 11 than at its lower end region 12. The sliding sleeve 5 may be introduced into the bearing sleeve 7 from below owing to the differing inner diameter and outer diameter, since an air gap is initially created between the inner surface of the bearing sleeve 7 and the outer surface of the sliding sleeve 5. If, during assembly, the upper end region 9 of the sliding sleeve 5 arrives at the upper end region 11 of the bearing sleeve 7, contact is generated between the sliding sleeve 5 and the bearing sleeve 7. At the same time, contact is generated here between the lower end regions 10 and 12 so that the sliding sleeve 5 ultimately abuts against the bearing sleeve 7 via two contact regions. Between the contact regions, clearances are generated between the sliding sleeve 5 and the bearing sleeve 7. A magnetic element 13 is inserted into the bearing sleeve 7 below the sliding sleeve 5. The magnetic element 13 serves primarily for shielding the elements of the blow-off valve 1 below the sliding sleeve 5 from the magnetic field lines produced by the electromagnet 3. The magnetic element 13 is formed as a disk-shaped ring element.

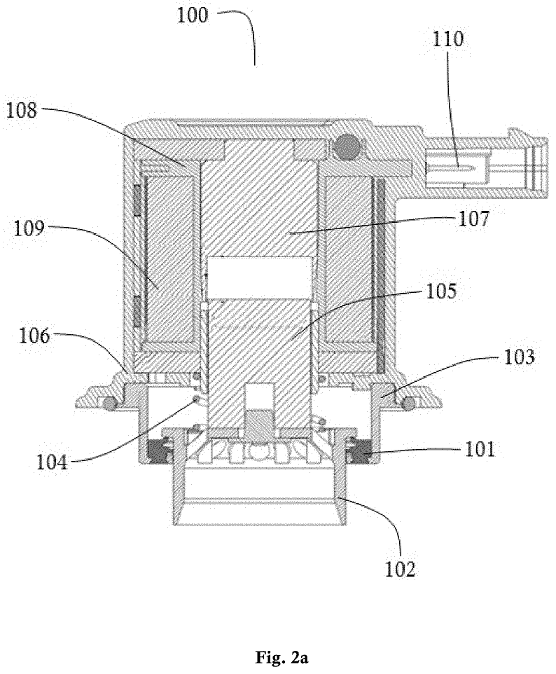

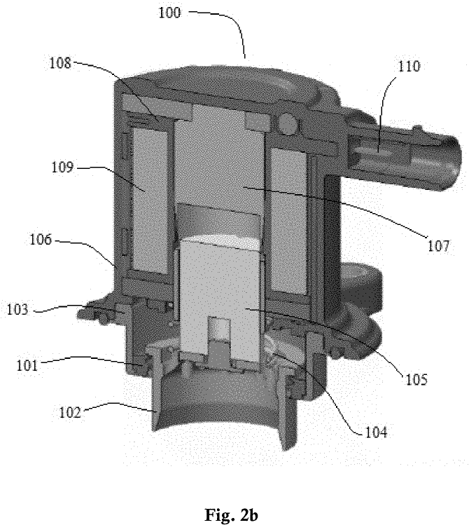

FIGS. 2a and 2b show the sectional and side cross-sectional view of a blow-off valve 100 with two axis internal seal ring 101. Further, the blow-off valve 100 comprises a plunger body 102 made up of material such as, but not limited to like thermoplastic, etc., and also act as a spring seat is fixed and secured inside a plunger housing 103 with a compression spring 104. The plunger body 102 is provided with means of pins, inserts, etc. which allows it to assembled into the moving core 105 without any additional attachments. Plunger body 102 then inserted into the plunger housing 103 using a two axis internal seal ring 101 which improves the leakage in between them in axial and radial direction. Further, the over molded coil housing 106 and plunger housing 103 are press fitted and sealed to form a fully functional blow-off valve. The fix core 107 provides a magnetic path to attract the moving core 105 upward against the spring force of the compression spring 104 when coil is energized. When the coil is de-energized, the moving core 105 is separated from the fixed core 107 by the action of compression spring 104 to return the plunger body 102 in the opposite direction. Further, an over molded coil housing 106 includes a bobbin 108 formed from an electrically insulated material such as, thermoplastics, nylon, etc., with a bore extending axially. Further, a metallic coil 109 of conducting material such as copper is then wound or wrapped around the bobbin 108, which when energized sets up a magnetic field. At the distal end of bobbin 108, a fix core 107 is attached. At the one end, terminal pins 110 are connected with in bobbin 108 to which coil's end are connected for receiving electrical input.

In another embodiment of the present invention, the two axis internal seal ring 101 will remains fix in its position i.e. in co-axial between plunger housing 103 and plunger body 102 while operation and let the plunger body 102 to perform opening and closing which result in lower opening and closing time of blow-off valve 100 and have less chances of wear and tear. The two axis internal seal ring 101 is having two lips for sealing leakage from horizontal as well as vertical surface between the plunger housing 103 and plunger body 102. The two axis internal seal ring 101 is made of preferably a compressible material. Further, it allows dimensional flexibility for sealing depth of overall blow-off valve 100 because of its own compressibility.

In another embodiment of the present invention, the blow-off valve 100 with two axis internal seal ring 101 assist in reducing child parts such as sliding and bearing sleeves in overall assembly which improves the design complexity and assist in low manufacturing cost.

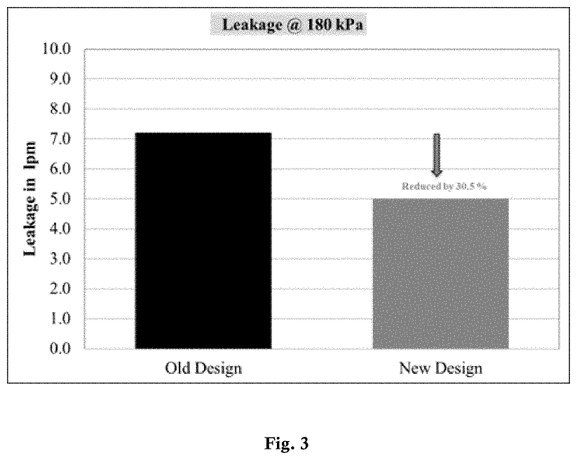

FIG. 3 shows the valve leakage performance between conventional blow-off valve and blow-off valve with two axis internal seal ring in accordance with an embodiment of the present invention. The blow-off valve with two axis internal seal ring shows a 30-35% reduction in leakage at a pressure of 180 kPa. The tolerance in a conventional design is 17.0±0.15 mm and the tolerance in the blow off valve in the present invention is 17.0±0.3 mm ensures improved leakage.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

We claim:

1. A blow off valve (100) with improved internal leakage comprising of:
a plunger body (102), a compression spring (104), a moving core (105), a two axis internal seal ring (101), a fix core (107), a bobbin (108), a metallic coil (109), a coil housing (106), a plunger housing (103) and a plurality of terminal pins (110);
wherein,
the two axis internal seal ring (101) remains fixed co-axially between the plunger housing (103) and the plunger body (102);
the two axis internal seal ring (101) is having two lips for sealing leakage from horizontal as well as vertical surface between the plunger housing (103) and plunger body (102); and
the two axis internal seal ring (101) reduces the leakage by 30-35% at a pressure of 180 kPa in axial and radial direction.

2. The blow off valve (100) as claimed in claim 1, wherein the plunger body (102) is provided with a means of pins and inserts that allow the plunger body (102) to assemble into the moving core (105).

3. The blow off valve (100) as claimed in claim 1, wherein the plunger body (102) inserted into the plunger housing (103) using the two axis internal seal ring (101) improves the internal leakage in axial and radial direction.

4. The blow off valve (100) as claimed in claim 1, wherein the two axis internal seal ring (101) is made of preferably a compressible material.

5. The blow off valve (100) as claimed in claim 1, wherein the plunger body (102) acts as a spring seat that is fixed and secured inside the plunger housing (103) with the compression spring (104).

6. The blow off valve (100) as claimed in claim 1, wherein the two axis internal seal ring (101) reduces the opening and closing time of valve (100) and chances of wear and tear.
